(19) United States
(12) Patent Application Publication
(10) Pub. No.: US 2014/0109867 A1
(43) Pub. Date: Apr. 24, 2014

(54) MULTI-FUNCTION CHOKE SWITCH

(71) Applicant: TECHTRONIC OUTDOOR PRODUCTS TECHNOLOGY LIMITED, Hamilton HM (BM)

(72) Inventors: Sven Eschrich, Berglen (DE); Benjamin Montgomery, Anderson, SC (US); Michael Rehner, Untergroeningen (DE)

(73) Assignee: Techtronic Outdoor Products Technology Limited, Hamilton HM (BM)

(21) Appl. No.: 13/656,129

(22) Filed: Oct. 19, 2012

(51) Int. Cl. F02M 7/26; F02D 9/08

(52) U.S. Cl. 123/337; 261/44.1; 261/44.6

(57) ABSTRACT

A choke assembly for an internal combustion engine comprising a user interface, a fuel valve, and a choke valve. The choke assembly further comprising an off position, in which the user interface is in a first position, the fuel valve is in a closed position, and the choke valve is in a closed position; a start position, in which the user interface is in a second position, the fuel valve is in an open position, and the choke valve is in the closed position; and a run position, in which the user interface is in a third position, the fuel valve is in the open position, and the choke valve is in an open position.

### BACKGROUND

The present invention relates to a choke switch for an internal combustion engine.

### SUMMARY

A choke is used to activate a choke valve, which is used to control the flow of air to an internal combustion engine. A restriction of airflow enriches the fuel-air mixture, which promotes starting of a cold internal combustion engine.

In some embodiments, the internal combustion engine is used in combination with an alternator to form an engine-generator. In the engine-generator, the internal combustion engine drives an output shaft coupled to a rotor of the alternator. The driving force of the internal combustion engine rotates the rotor, inducing electric current to be output by a stator of the alternator. Thus, the mechanical energy of the internal combustion engine is converted to electric energy.

In one embodiment, the invention provides a choke assembly for an internal combustion engine comprising a user interface having a first position, a second position, and a third position; a fuel valve having an open position and a closed position, the open position for supplying fuel to the internal combustion engine, and the closed position for preventing the supply of fuel to the internal combustion engine; and a choke valve having an open position and a closed position, the closed position allowing less air flow to the internal combustion engine than the open position. The choke assembly further comprising an off position, in which the user interface is in the first position, the fuel valve is in the closed position, and the choke valve is in the closed position; a start position, in which the user interface is in the second position, the fuel valve is in the open position, and the choke valve is in the closed position; and a run position, in which the user interface is in the third position, the fuel valve is in the open position, and the choke valve is in the open position.

In another embodiment the invention provides a method of operating a choke assembly for an internal combustion engine. The choke assembly includes a user interface having a first position, a second position, and a third position; a fuel valve having an open position and a closed position, the open position for supplying fuel to the internal combustion engine, and the closed position for preventing the supply of fuel to the internal combustion engine; and a choke valve having an open position and a closed position, the closed position allowing less air flow to the internal combustion engine than the open position. The method comprises positioning the choke assembly in an off position, in which the user interface is in the first position, the fuel valve is in the closed position, and the choke valve is in the closed position; positioning the choke assembly in a start position, in which the user interface is in the second position, the fuel valve is in the open position, and the choke valve is in the closed position; and positioning the choke assembly in a run position, in which the user interface is in the third position, the fuel valve is in the open position, and the choke valve is in the open position; wherein the fuel valve is coupled to the user interface.

Other aspects of the invention will become apparent by consideration of the detailed description and accompanying drawings.

### BRIEF DESCRIPTION OF THE DRAWINGS

FIG. 1 is a perspective view of a first embodiment of a choke assembly.

FIG. 2 is a top view of the choke assembly of FIG. 1 in an OFF position.

FIG. 3 is a top view of the choke assembly of FIG. 1 in an START position.

FIG. 4 is a top view of the choke assembly of FIG. 1 in an RUN position.

FIG. 5a is a perspective view of a second embodiment of a choke assembly in an OFF position.

FIG. 5b is a top view of the choke assembly of FIG. 5a in the OFF position.

FIG. 6a is a perspective view of the choke assembly of FIG. 5a in the START position.

FIG. 6b is a top view of the choke assembly of FIG. 5a in the START position.

FIG. 7a is a perspective view of the choke assembly of FIG. 5a in the RUN position.

FIG. 7b is a top view of the choke assembly of FIG. 5a in the RUN position.

FIGS. 8a and 8b illustrate an engine-generator including a choke assembly according to embodiments of the invention.

FIG. 9 illustrates an electric circuit of an engine-generator according to embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

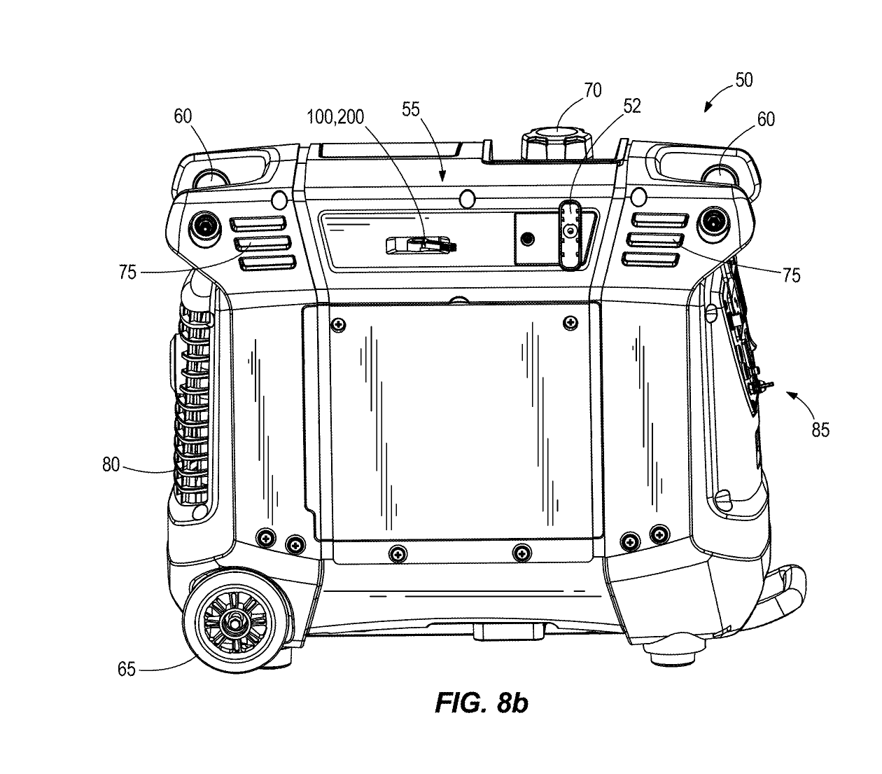

FIGS. 8a and 8b illustrate an engine-generator 50 having a choke assembly according to embodiments of the invention. The engine-generator 50 includes a choke assembly 100 or 200, an internal combustion engine, and an alternator. In the construction illustrated in FIG. 8a the engine-generator 50 includes a switch 165 and a starter motor for starting the engine-generator 50. In the construction illustrated in FIG. 8b the engine-generator 50 includes a starter pull cord 52 for starting the engine-generator 50, rather than the switch 165 and the starter motor. In another construction, the engine-generator 50 includes the starter 165, starter motor, and starter pull cord 52. The engine-generator 50 further includes a housing 55, handles 60, wheels 65, and a fuel cap 70 providing selective access to an internal fuel tank. The engine-generator 50 also includes air inlet ports 75 through which cooling air is drawn. The cooling air is exhausted through outlet port 80. A panel 85 includes one or more AC outlets and DC outlets, user feedback LEDs, and actuators for user control inputs. An extendable/retractable handle by which to pull the engine-generator 50 via wheels 65 is hidden beneath the housing 55.

### First Embodiment

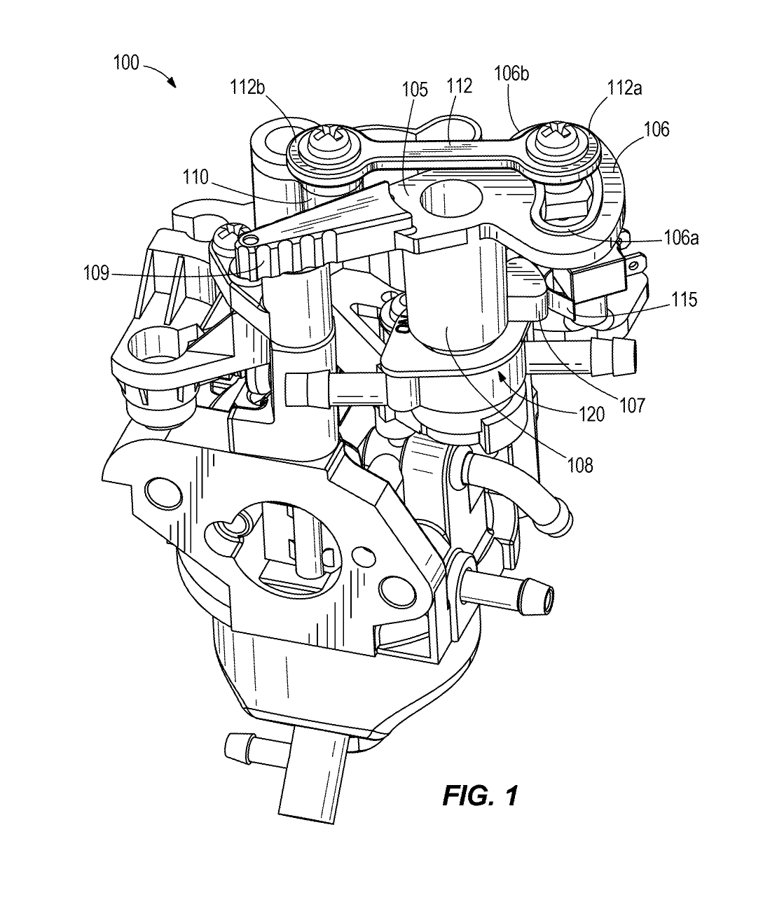

FIGS. 1-4 illustrate a choke assembly 100 for use with the internal combustion engine. The choke assembly 100 includes a user interface 105, a choke 110, a starter switch 115, and a fuel valve 120. The choke assembly 100 has three modes of operation: OFF, START, and RUN. When in the OFF mode, the internal combustion engine is in an OFF state. When in the START mode the internal combustion will turn on. When in the RUN mode the internal combustion engine will run as long as the choke assembly 100 remains in the RUN mode, assuming that the engine has sufficient fuel, does not malfunction, etc.

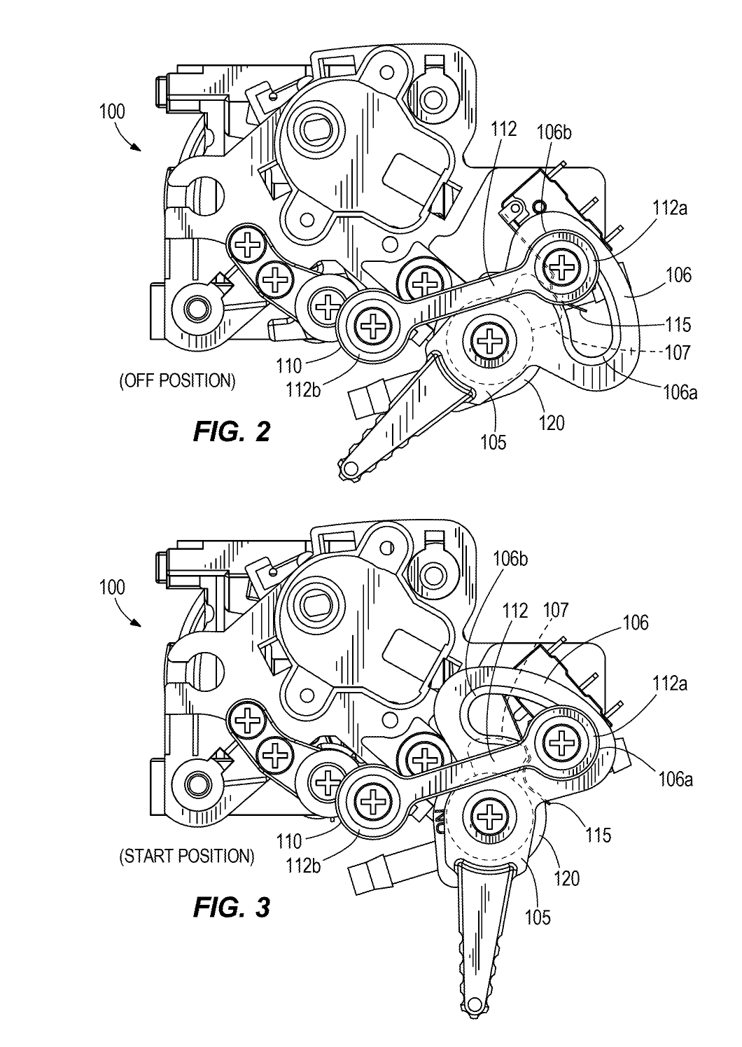

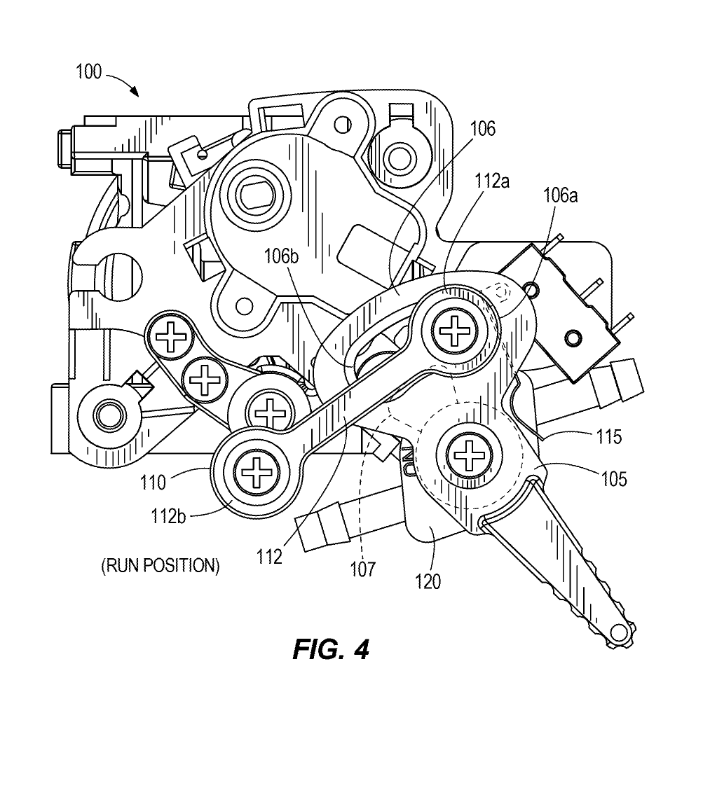

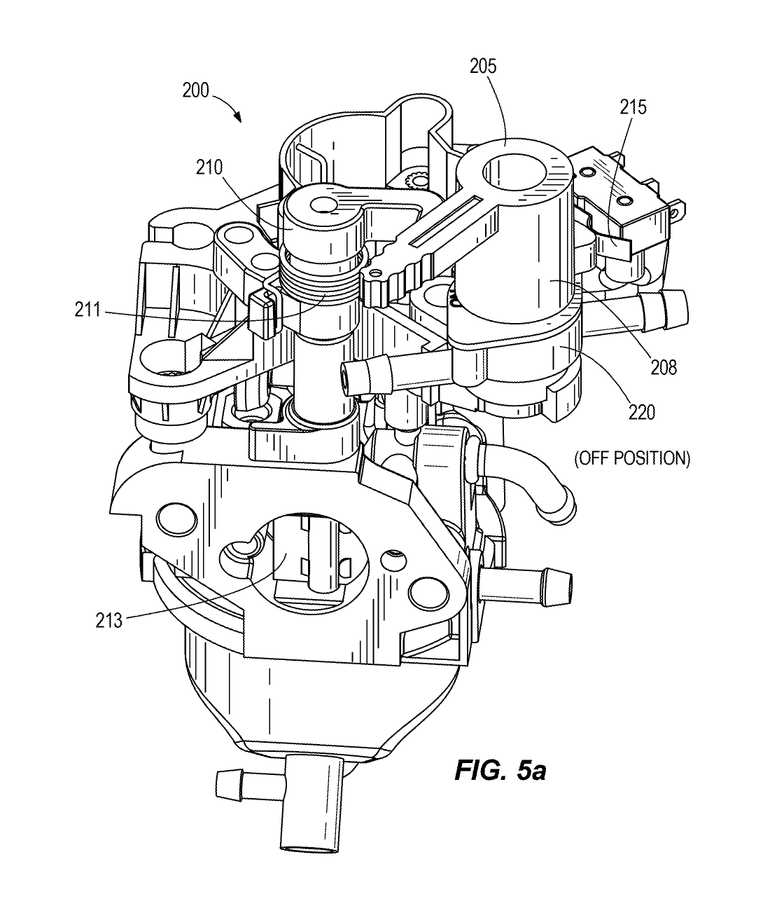

The user interface 105 has three positions which correspond to the three modes of the choke assembly 100: an OFF position also known as a first position (shown in FIGS. 1 & 2), a START position also known as a second position (shown in FIG. 3), and a RUN position also known as a third position (shown in FIG. 4). As shown in the illustrated embodiment of FIGS. 2-4, the user interface 105 moves from the OFF position to the START position, and from the START position to the RUN position. The user interface 105 includes a choke interface 106, a starter switch interface 107, a fuel valve interface 108, and a user-movable tab 109. The choke interface 6 is a curved slot including a first side 106a and a second side 106b.

The choke 110 restricts air flow into the internal combustion engine. Restriction of air flow enriches the fuel/air mixture of the internal combustion engine, which promotes starting of a cold internal combustion engine. When the choke 110 is in a closed position, the choke 10 is activated and air flow into the internal combustion engine is restricted. When the choke 110 is in an open position, the choke 110 is deactivated and air flow into the internal combustion engine is not restricted. The choke 110 is connected to the choke interface 106 by a connecting rod 112, having a connecting rod side 112a and a connecting rod side 112b.

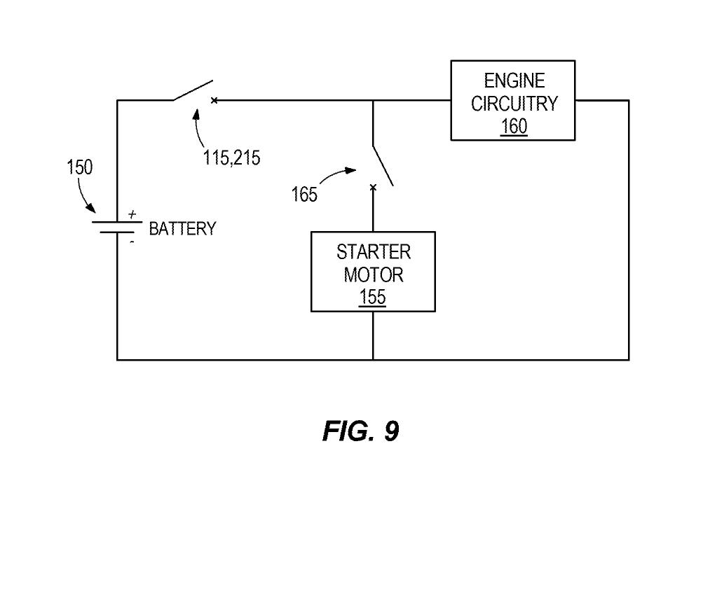

In some constructions, the starter switch 115 is springingly biased in the closed position. In some constructions, as shown in FIG. 9, the starter switch 115 is an electric switch coupled in series with a battery 150 and engine circuitry 155. The engine circuitry 155 includes, for instance, spark plug timing circuitry. When open, the starter switch 115 creates an open circuit such that the engine circuitry 155 does not receive power and the engine-generator cannot operate. In other words, if the starter switch 115 is open, the engine-generator will not start or, if already operating, will shut down. When the starter switch 115 is in a closed position, it no longer prevents current flow from the battery 150 to the engine circuitry 155. Thus, the engine may be started via an electric starter motor 160 or the starter pull cord 52.

In embodiments with an electric starter motor 160, the engine-generator includes a switch 165 (e.g., push-button switch) that connects the electric starter motor 160 to the battery 150, assuming that the starter switch 115 is also closed. Upon activation, the electric starter motor 160 starts the internal combustion engine by rotating the engine until the engine operates under its own combustion power. In embodiments with the starter pull cord 52, the user pulls the starter pull cord 52, which rotates the internal combustion engine until the engine operates under its own combustion power. In such embodiments, the circuit diagram of FIG. 9 is similar, except that the electric starter motor 160 and switch 165 are removed. In some embodiments, the engine-generator includes both the electric starter motor 160 and the starter pull cord 52, and the user may selectively use either for starting.

The fuel valve 120 is coupled to the user interface 105 and regulates the flow of fuel to the internal combustion engine. When the fuel valve 120 is in a closed position, the flow of fuel to the internal combustion engine is obstructed. When the fuel valve 120 is in an open position, fuel is provided to the internal combustion engine. In some constructions, the fuel valve 120 includes a paddle that obstructs or allows the flow of fuel through the fuel line to the internal combustion engine. For instance, by rotation of the user interface 105 and fuel value interface 108 about an axis of rotation, the paddle also rotates about an axis of rotation to open or close a fuel flow path. In some constructions, the paddle and user interface 105 rotate coaxially and, when the user interface 105 is rotated, the paddle rotates in substantially the same direction. In some constructions, the paddle is integral with fuel valve interface 108 of the user interface 105. In other constructions, the paddle and fuel valve interface 108 include a multi-piece structure. In some constructions, a coaxially rotatable obstruction other than a paddle, or another valve type, is used as the fuel valve to selectively allow and prevent fuel to flow in the fuel line.

In operation, when the internal combustion engine is in the off position, the choke assembly 1 is in the OFF mode (as shown in FIG. 2). When the choke assembly 100 is in the OFF mode, the user interface 105 is in the first position, the choke 110 is in the closed position, the starter switch interface 107 holds the starter switch 115 in the open position, and the fuel valve 120 is in the closed position.

To start the internal combustion engine, a user moves the user-movable tab 109 thus moving the user interface 105 from the first position to the second position, thereby placing the choke assembly 100 in the START mode (as shown in FIG. 3). As the user interface 105 is moved to the second position, the starter switch interface 107 is moved away from the starter switch 115 allowing the starter switch 115 to move to the closed position. Simultaneously, the fuel valve interface 108 of the user interface 105 moves the fuel valve 120 into the open position, thereby allowing fuel to flow to the internal combustion engine. Thereafter, with the starter switch 115 closed and the fuel valve 120 opened, the user may activate the electric starter motor or pull the starter pull cord 52 to start the internal combustion engine. While the user interface 105 is moved to the second position, the choke interface first side 106a is moved away from the connecting rod side 112a and the choke interface second side 106b comes into contact with the connecting rod side 112a. The connecting rod 112 does not move the choke 110 and the choke 110 remains in the closed position restricting air flow to promote starting of the internal combustion engine.

Once the internal combustion engine has started, the user moves the user-movable tab 109 thus moving the user interface 105 to the third position, thereby placing the choke assembly 100 in the RUN mode (as shown in FIG. 4). As the user interface 105 is moved to the third position, the choke interface second side 106b moves the connecting rod side 112a, which in turn moves the choke 110, via the connecting rod side 112b, from the closed position to the open position. The fuel valve 120 remains in the open position thereby continuing to allow fuel to reach the internal combustion engine.

To turn off the internal combustion engine, the user moves the user-movable tab 109 thus moving the user interface 105 back to the first position, thereby placing the choke assembly 100 in the OFF mode (as shown in FIG. 2a). When in the OFF mode, the fuel valve 120 is in the closed position restricting the fuel flow to the internal combustion engine and the starter switch 115 is open thus creating an open circuit in the electrical circuitry of the engine-generator.

### Second Embodiment

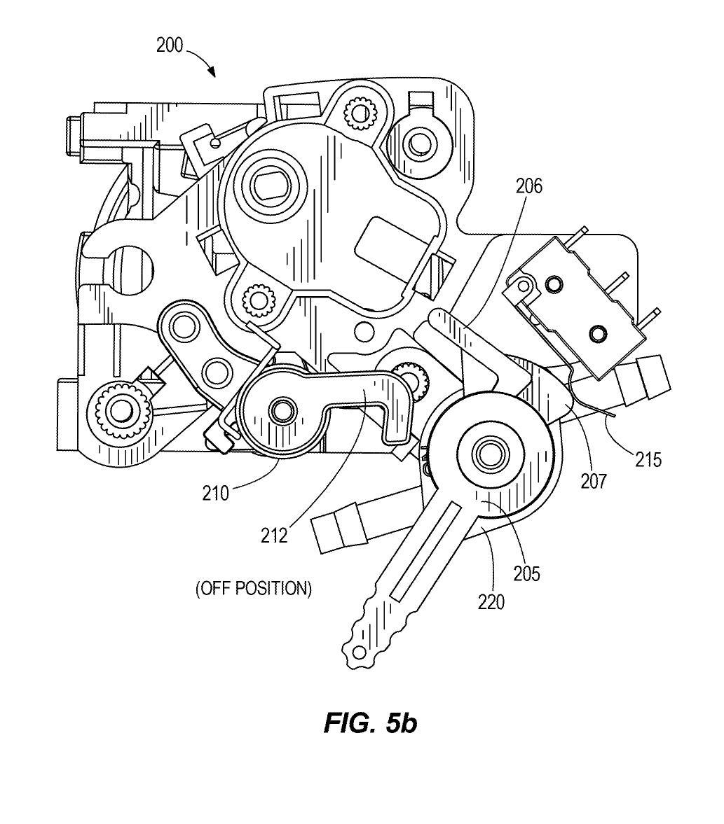

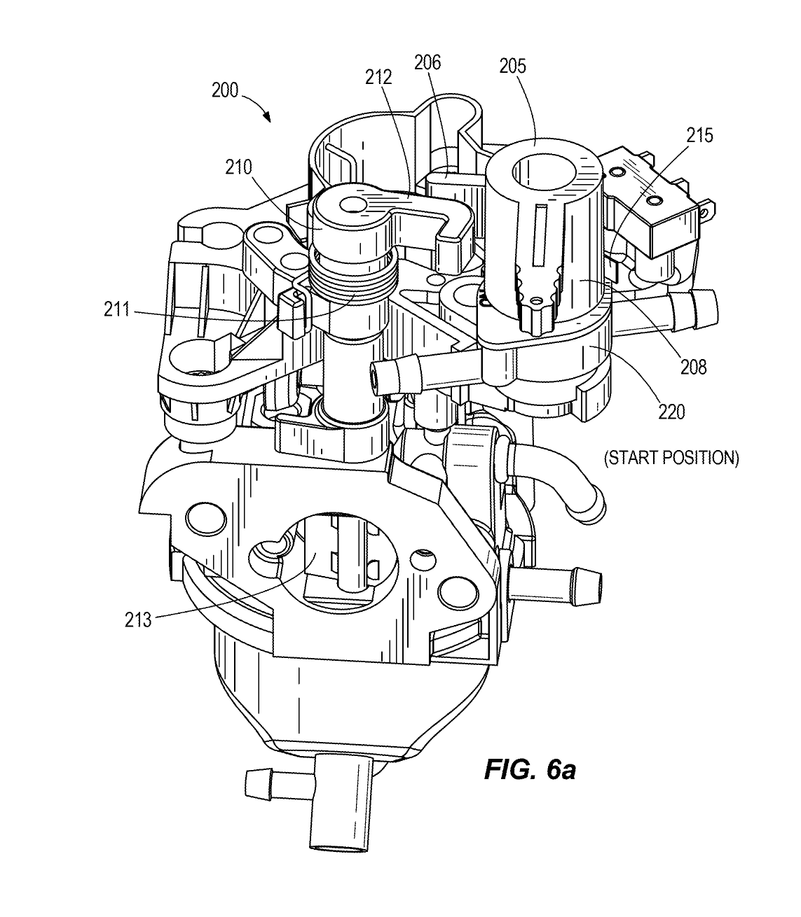

FIG. 5-7 illustrate a second embodiment of a choke assembly 200. The choke assembly 200 includes a user interface 205, a choke 210, a starter switch 215, and a fuel valve 220. The choke assembly 200 has three modes of operation: OFF, START, and RUN. When in the OFF mode, the internal combustion engine is in an OFF state. When in the START mode the internal combustion will turn on. When in the RUN mode, the internal combustion will run as long as the choke assembly 200 remains in the RUN mode, assuming that the engine has sufficient fuel, does not malfunction, etc.

The user interface 205 has three positions which correspond to the three modes of the choke assembly 200: an OFF position also known as a first position, a START position also known as a second position, and a RUN position also known as a third position. As shown in the illustrated embodiment of FIGS. 5-7, the user interface 205 moves from the OFF position to the START position, and from the START position to the RUN position. The user interface 205 includes a choke interface 206, a starter switch interface 207, and a fuel valve interface 208.

The choke 210 has a closed position and an open position. The choke 210 includes a choke spring 211, a choke arm 212, and a choke valve 213. The choke spring 211 biases the choke valve 213 closed, thus placing the choke 210 in the closed position. The choke arm 212 interacts with the choke interface 206 of the user interface 205.

The starter switch 215 is similar to the starter switch 115 of the first embodiment and as illustrated in FIG. 9. The starter switch 215 has an open position and a closed position. When open, the starter switch 225 creates an open circuit such that the engine circuitry 155 does not receive power and the engine-generator cannot operate. In other words, if the starter switch 215 is open, the engine-generator will not start or, if already operating, will shut down. When the starter switch 215 is in a closed position, it no longer prevents current flow from the battery 150 to the engine circuitry 155. Thus, the engine may be started via an electric starter motor 160 or the starter pull cord 52. In some embodiments, the engine-generator includes the starter pull cord 52 in place of or in addition to the electric starter motor 160. In some constructions, the starter switch 115 is springingly biased in the closed position.

The fuel valve 220 is coupled to the user interface 205 and is similar to the fuel valve 220 of the first embodiment. When the fuel valve 220 is in a closed position the flow of fuel to the internal combustion engine is obstructed. When the fuel valve 220 is in an open position fuel is provided to the internal combustion engine. In some constructions, the fuel valve 220 includes a paddle that obstructs or allows the flow of fuel through the fuel line to the internal combustion engine. For instance, by rotation of the user interface 205 and fuel value interface 208 about an axis of rotation, the paddle also rotates about an axis of rotation to open or close a fuel flow path. In some constructions, the paddle and user interface 205 rotate coaxially and, when the user interface 205 is rotated, the paddle rotates in substantially the same direction. In some constructions, the paddle is integral with fuel valve interface 208 of the user interface 205. In other constructions, the paddle and fuel valve interface 208 include a multi-piece structure. In some constructions, a coaxially rotatable obstruction other than a paddle, or another valve type, is used as the fuel valve to selectively allow and prevent fuel to flow in the fuel line.

In operation, when the choke assembly 200 is in the OFF mode the internal combustion engine is in the OFF state (as shown in FIGS. 5a & 5b). When the choke assembly 200 is in the OFF mode, the user interface 205 is in the first position, the choke 210 is in the closed position, the starter switch interface 207 holds the starter switch 215 in the open position, and the fuel valve 220 is in the closed position.

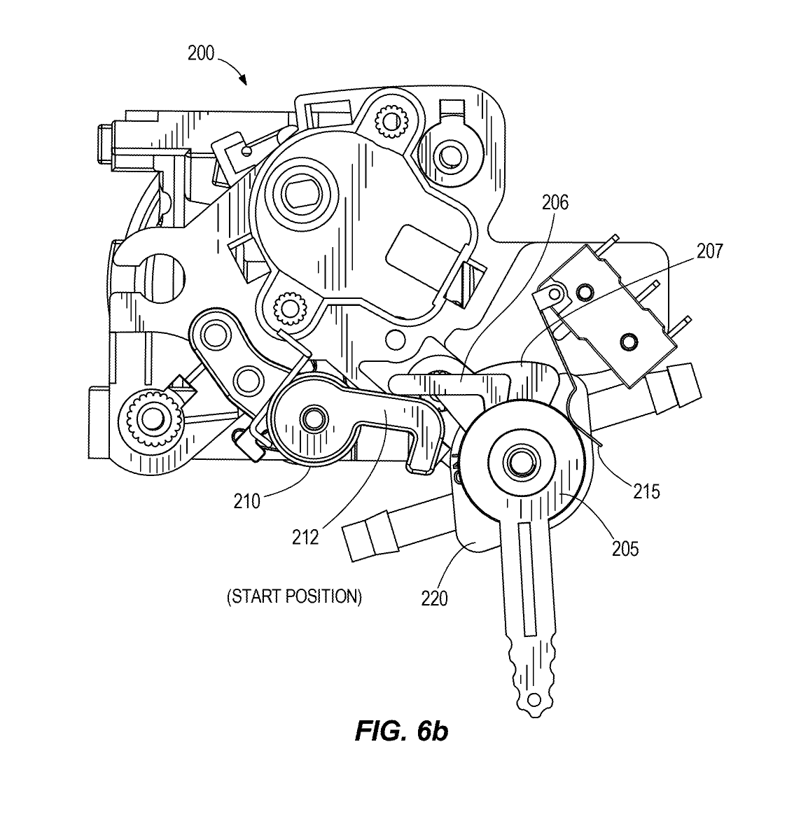

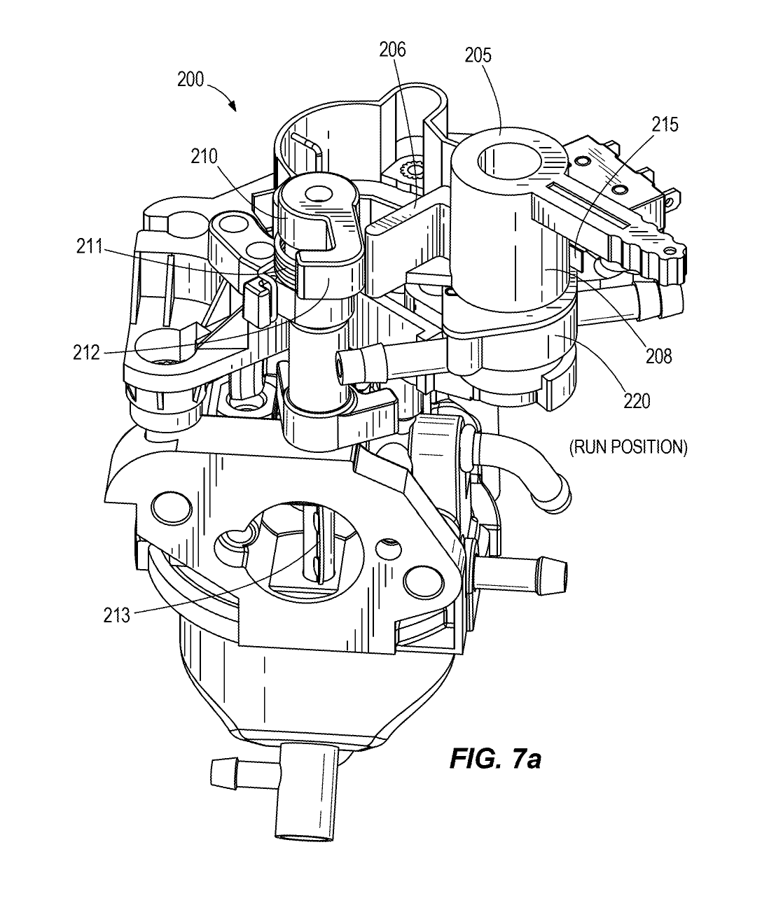

To start the internal combustion engine a user moves the user interface 205 to the second position, thereby placing the choke assembly 200 in the START mode (as shown in FIGS. 6a & 6b). As the user interface 205 is moved to the second position, the starter switch interface 106 is moved away from the starter switch 215 allowing the starter switch 215 to move to the closed position. Simultaneously, the fuel valve interface 208 of the user interface 205 moves the fuel valve 220 into the open position, thereby allowing fuel to flow to the internal combustion engine. Thereafter, with the starter switch 215 closed and the fuel valve 220 opened, the user may activate the electric starter motor or pull the starter pull cord 52 to start the internal combustion engine.

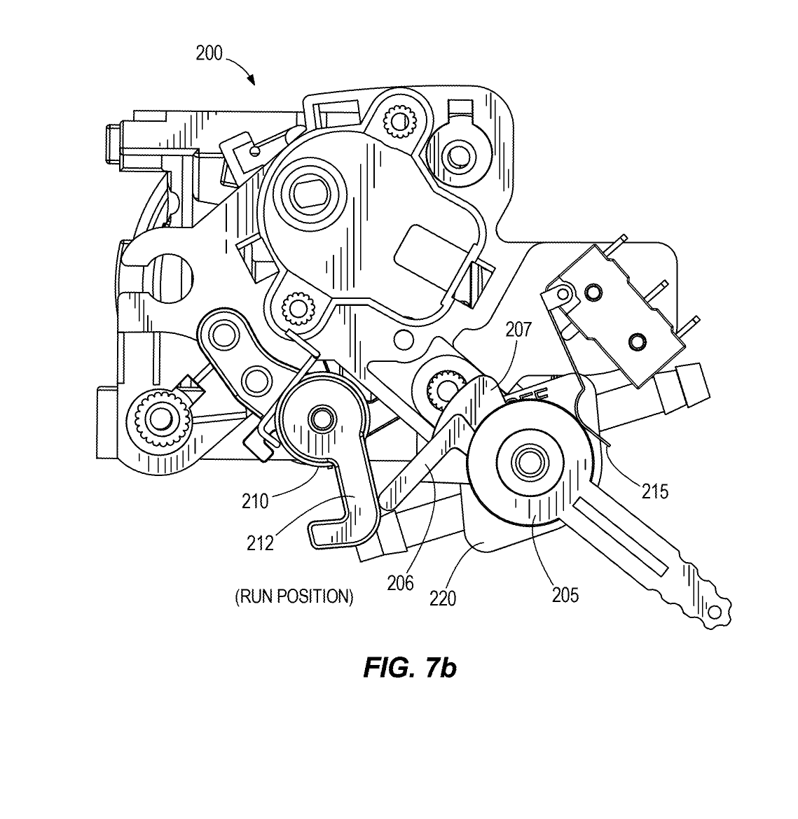

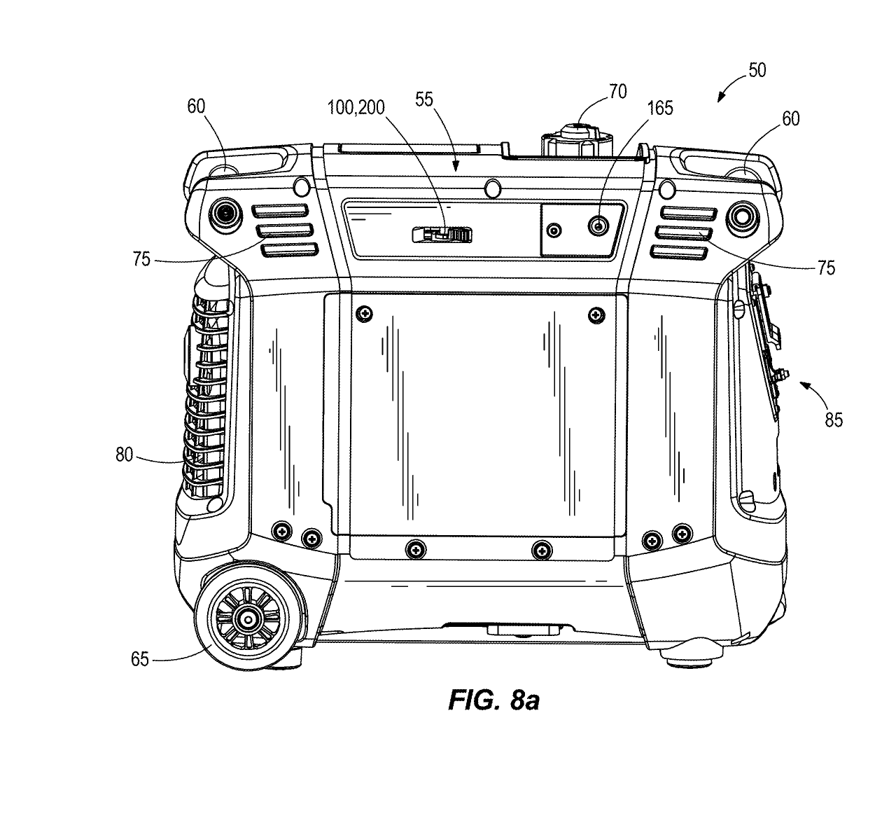

Once the internal combustion engine has started, the user moves the user interface 105 to the third position, thereby placing the choke assembly 200 in the RUN mode (as shown in FIGS. 7a & 7b). As the user interface 205 is moved to the third position, the choke interface 206 interacts with the choke arm 212. As the choke interface 206 moves the choke arm 212, the choke valve 213 is rotated open thus moving the choke 210 from the closed position to the open position. The fuel valve 220 remains in the open position thereby allowing fuel to the internal combustion engine.

To turn off the internal combustion engine the user moves the user interface 205 back to the first position, thereby placing the choke assembly 200 in the OFF mode (as shown in FIGS. 5a & 5b). When in the OFF mode, the fuel valve 220 is in the closed position restricting the fuel flow to the internal combustion engine.

Thus, the invention provides, among other things, a choke assembly for use with an internal combustion engine. Various features and advantages of the invention are set forth in the following claims.

What is claimed is:

1. A choke assembly for an internal combustion engine comprising:
a user interface having a first position, a second position, and a third position;
a fuel valve coupled to the user interface and having an open position and a closed position, the open position for supplying fuel to the internal combustion engine, and the closed position for preventing the supply of fuel to the internal combustion engine;
a choke valve having an open position and a closed position, the closed position allowing less air flow to the internal combustion engine than the open position;
an off position in which the user interface is in the first position, the fuel valve is in the closed position, and the choke valve is in the closed position;
a start position in which the user interface is in the second position, the fuel valve is in the open position, and the choke valve is in the closed position; and
a run position in which the user interface is in the third position, the fuel valve is in the open position, and the choke valve is in the open position.

2. The choke assembly of claim 1, further comprising
a starter switch having an open position and a closed position, the open position for isolating a power source from engine circuitry, and the closed position for making a conducting path,
wherein, in the off position, the starter switch is in the open position and, in the start position, the starter switch is in the closed position.

3. The choke assembly of claim 2, wherein the starter switch is biased in the closed position.

4. The choke assembly of claim 2, wherein movement of the user interface from the first position to the second position moves the starter switch to the closed position and the fuel valve to the open position.

5. The choke assembly of claim 1, wherein movement of the user interface from the second position to the third position moves the choke valve from the closed position to the open position.

6. The choke assembly of claim 1, further comprising a starter pull cord.

7. The choke assembly of claim 6, wherein the starter pull cord is operable to start the internal combustion engine when the choke assembly is in the start position or the run position.

8. The choke assembly of claim 1, wherein the choke assembly moves from the off position, through the start position, to the run position.

9. The choke assembly of claim 1, wherein the choke assembly is coupled to and controls an engine-generator.

10. The choke assembly of claim 1, wherein the choke valve is biased in the closed position by a spring.

11. The choke assembly of claim 1, wherein the user interface is a rotatable actuator having an axis of rotation and a curved slot on an opposite side of the axis of rotation as a user-moveable tab.

12. The choke assembly of claim 1, further comprising a connecting rod having a first end and a second end, the first end coupled to a curved slot of the user interface, the second end rotatably coupled to the choke valve, wherein
rotation of the user interface from the first position to the second position moves the curved slot with respect to the first end of the connecting rod, and
rotation of the user interface from the second position to the third position moves the curved slot while moving the connecting rod, thereby moving the choke valve to the open position.

13. The choke assembly of claim 1, wherein the user interface includes a choke interface and the choke valve includes a choke arm, rotation of the user interface from the second position to the third position moves the choke interface into contact with the choke arm and moves the choke arm, thereby moving the choke valve to the open position.

14. The choke assembly of claim 1, wherein the fuel valve is coaxial with the user interface.

15. A method of operating a choke assembly for an internal combustion engine, the choke assembly including a user interface having a first position, a second position, and a third position, a fuel valve having an open position for supplying fuel to the internal combustion engine and a closed position for preventing the supply of fuel to the internal combustion engine, and a choke valve having an open position and a closed position, the closed position allowing less air flow to the internal combustion engine than the open position, the method comprising:
positioning the choke assembly in an off position in which the user interface is in the first position, the choke valve is in the closed position, and the fuel valve, which is coupled to the user interface, is in the closed position;
positioning the choke assembly in a start position in which the user interface is in the second position, the fuel valve is in the open position, and the choke valve is in the closed position; and
positioning the choke assembly in a run position in which the user interface is in the third position, the fuel valve is in the open position, and the choke valve is in the open position.

16. The method of claim 15,
wherein the choke assembly further comprises a starter switch, the starter switch having an open position and a closed position, the open position for isolating a power source from engine circuitry, and the closed position for making a conducting path, and
wherein, in the off position, the starter switch is in the open position and, in the start position, the starter switch is in the closed position.

17. The method of claim 16, wherein the starter switch is biased in the closed position.

18. The method of claim 16, further comprising rotating the user interface from the first position to the second position to move the starter switch to the closed position and the fuel valve to the open position.

19. The method of claim 15, further comprising rotating the user interface from the second position to the third position to move the choke valve from the closed position to the open position.

20. The method of claim 15, wherein the choke assembly further comprises a starter pull cord.

21. The method of claim 20, further comprising pulling the starter pull cord to start the internal combustion engine when the choke assembly is in the start position or the run position.

22. The method of claim 15, further comprising rotating the choke assembly to move from the off position, through the start position, to the run position.

23. The method of claim 15, wherein the choke assembly is coupled to and controls an engine-generator.

24. The method of claim 15, wherein the choke valve is biased in the closed position by a spring.

25. The method of claim 15, wherein the user interface is a rotatable actuator having an axis of rotations and a curved slot on an opposite side of the axis of rotation as a user-moveable tab.

26. The method of claim 15, including a connecting rod having a first end and a second end, the first end coupled to a curved slot of the user interface, the second end rotatably coupled to the choke valve, wherein
rotation of the user interface from the first position to the second position moves the curved slot with respect to the first end of the connecting rod, and
rotation of the user interface from the second position to the third position moves the curved slot while moving the connecting rod, thereby moving the choke valve to the open position.

27. The method of claim 15, further comprising rotating the user interface from the second position to the third position to move a choke interface of the user interface into contact with a choke arm of the choke valve, thereby moving the choke valve to the open position.

28. The method of claim 15, wherein the fuel valve is coaxial with the user interface.
